(19) United States
(12) Patent Application Publication
(10) Pub. No.: US 2007/0128398 A1
(43) Pub. Date: Jun. 7, 2007

(54) Roll of a label web in the form of an Archimedean spiral of labels disposed one behind another

(75) Inventor: Volker Hahn, Hamburg (DE)

Correspondence Address: NORRIS, MCLAUGHLIN & MARCUS, PA, 875 THIRD AVENUE, 18TH FLOOR, NEW YORK, NY, 10022, US

(73) Assignee: tesa AG, Hamburg (DE)

(21) Appl. No.: 11/494,560

(22) Filed: Jul. 27, 2006

(30) Foreign Application Priority Data
Dec. 2, 2005 (DE) 10 2005 057 932.9

(51) Int. Cl. B32B 33/00

(52) U.S. Cl. 428/42.3; 428/40.1

(57) ABSTRACT

Roll of a label web in the form of an Archimedean spiral of labels disposed one behind another and composed at least of a backing coated on one side with an adhesive, the labels being lined with a liner on the adhesive side, characterized in that the liner is diecut down to the labels and additionally forms a continuous web divided into individual sections, and the cut lines of the liner are located at an offset to the cross-cut lines of the labels such that beneath each label there is at least one cut line of the liner.

The invention relates to a roll of a label web in the form of an Archimedean spiral of labels disposed one behind another and composed at least of a backing coated on one side with an adhesive, the labels being lined with a liner on the adhesive side, and to processes for producing the label roll.

In the case of a roll of a label web in the form of an Archimedean spiral of labels disposed one behind another and composed at least of a backing coated on one side with an adhesive, the labels being lined with a liner on the adhesive side, typically the liner is not kiss-cut or perforated.

In the dispensing operation the labels are removed from the liner, while the liner, if desired, is wound up before being discarded.

This can be observed typically for rolls of price labels, which are applied by means of a dispenser to the product to be priced up, while the liner is occasionally shortened by hand.

In a first development the liner is perforated, in such a way that the perforation lies at the point at which two successive labels abut one another on the roll. If the labels are cut by means of matrix cutting, there is a space between two successive labels. In that case the perforation lies within this space. In this way, for the purpose of dispensing, the label can be separated, together with the liner, from the roll. Subsequently the liner is removed from the label, and the label is adhered.

Since it is always the whole adhesive area of the label that is lined, there is no possibility to utilize only part of the adhesive area, without making use of tools such as a scissors in order to cut off the partially removed liner, while the other part of the liner remains on the label.

If a label of this kind is used for sealing, it must form a loop or a circle around the article that is to be sealed, and must be bonded to itself again. A disadvantage in this context is that the label, particularly in the case of one with high bond strengths, is bonded on the one hand to itself and at the same time to the article that is to be sealed (for example, when sealing two metal rings, there is also adhesion to these rings). On parting (opening of the seal), the label is difficult to remove from the article. Often there remain residues of adhesive on the article.

It is an object of the present invention to make available a dispensing form for labels that allows them to be dispensed easily and that allows the labels to be applied as an adhesive seal without the label clinging to the article to be sealed, and without waste in use.

This object is achieved by means of a roll of a label web in the form of an Archimedean spiral of labels disposed one behind another, as described hereinbelow.

The invention accordingly provides a roll of a label web in the form of an Archimedean spiral of labels disposed one behind another and composed at least of a backing coated on one side with an adhesive, the labels being lined with a liner on the adhesive side.

In accordance with the invention the liner is diecut down to the labels and additionally forms a continuous web divided into individual sections, and the cut lines of the liner are located at an offset to the cross-cut lines of the labels such that beneath each label there is at least one cut line of the liner.

In a first advantageous embodiment the labels disposed one behind another are each disposed at a distance from one another on the liner.

With further preference beneath a label there is only one single cut line of the liner.

In accordance with the invention the roll is wound such that relative to the roll centre the liner represents the inner ply and the labels represent the outer ply.

In a further advantageous embodiment of the invention the cut line of the liner is in the vicinity of the back edge of the label as viewed in the web direction.

By way of example the labels have a width of 20 to 25 mm and a length of 140 to 160 mm, and the cut line of the liner is at a distance of between 20 and 30 mm from the back edge of the label.

In spite of the label material being cut through (and hence the labels being singularized) and the liner being cut through at the same time, the result is a coherent chain of labels which are bonded to one another and can be wound into a roll, transported and dispensed compactly, without taking up space, and used in particular as adhesive seals. In such a chain the labels bridge each of the cuts within the liner and in that way connect the individual sections of the liner, which hence, overall, form a quasi-coherent web.

In the dispensing operation it is not the label that releases from the liner, in the usual way, but instead the liner from the label. As it lifts off, the liner exposes the adhesive surface with the security effect and hence also releases the individual adhesive seal label, which is immediately ready for adhesive use. Following singularization, there is no need for the liner to be removed by the user in an additional step of work. Moreover, at the application stage, no waste is produced that would require disposal in a further work-step.

In a further preferred embodiment a multilayer label stock material is used for producing the labels, with one or more additional layers being applied to the backing; some of these layers in particular may be applied partially.

These layers are primers and/or release layers, and of the release layers one or two are used in particular.

The critical factor is that the backing and each of the individual layers have different forces of adhesion among one another.

In a further preferred embodiment the labels are produced using a multilayer label stock material that has a backing based on an oriented thermoplastic film whose top face is coated, where appropriate, with a release coating and whose bottom face carries the following applied layers:
a primer layer which is not applied over the full area but is very well anchored to the thermoplastic film,
a release layer which is applied over the full area of the applied primer layer and the free surface of the thermoplastic film, the anchorage of the release layer to the primer layer being better than that to the thermoplastic film,
the adhesive applied over the full area to the release layer, its anchorage to the release layer being better than that of the release layer to the thermoplastic film.

In a further preferred embodiment the labels are produced using a multilayer label stock material that has a backing based on an oriented thermoplastic film whose top face is coated, where appropriate, with a release coating and whose bottom face carries the following applied layers:
a primer layer which is not applied over the full area but is very well anchored to the thermoplastic film,
a first release layer which is applied over the full area of the applied primer layer and the free surface of the thermoplastic film, the anchorage of the first release layer to the primer layer being better than that to the thermoplastic film,
a second release layer which is applied over the full area to the first release layer, the attachment of the second release layer to the first release layer being better than of the first release layer to the film surface, and the attachment of the second release layer to the first release layer being poorer than that of the adhesive to the substrate,
the adhesive applied over the full area to the second release layer, its anchorage to the second release layer being better than that of the second release layer to the first release layer.

With further preference these additional primer layers and release layers are applied to the backing only within a confined area, more preferably in the area which is produced when the cut line of the liner is disposed at the back edge of the label, in other words the area located between the back edge of the label, as the end of the label, and the cut line in the liner.

The backing and/or the thermoplastic film are preferably composed of paper or of films such as oriented HDPE, PVC, PET, of monoaxially oriented polypropylene or of biaxially oriented polypropylene, and in particular are transparent.

Films based on polyester, particularly for example polyethylene terephthalate, may also be used.

The thicknesses of films based on PET are between 20 and 100 μm, in particular between 30 and 50 μm.

Films based on oriented polyolefins are prior art. Monoaxially and biaxially oriented films based on polyolefins are used in large quantities for adhesive packaging tapes, strapping tapes and other adhesive tapes. Films based on oriented polyethylene or oriented copolymers containing ethylene and/or propylene units are known as well. All of these films recited can be employed as backings in accordance with the invention.

Particular preference for the backing is given to single-layer biaxially or monoaxially oriented films and multi-layer biaxial or monoaxial films based on polypropylene that exhibit a sufficiently firm bond between the layers, since delamination of the layers during the application is deleterious.

Release coatings of the kind applied where appropriate to the top surface of the film, in other words the surface that faces the adhesive, are in widespread use in the adhesive tape industry. An overview of release coating systems based on silicone and their use in the pressure-sensitive adhesives field is found in “Silicone Release coating” (D. Jones, Y. A. Peters in Handbook of Pressure Sensitive Adhesive Technology, Third Edition, edited by Donatas Satas, Van Reinhold New York, pages 652 to 683).

The use of reverse-phase release coatings results in easy and uniform unwind. Release coatings employed in particular in this context are those based on solventborne carbamate systems and on silicone-based systems.

Release coatings based on silicone systems are suitable for the labels of the invention. Preferred release coatings are UV-curing silicone systems on a 100% basis, although solventborne silicone systems can also be used as release coatings for the adhesive tapes of the invention.

The coatweight of the release coating on the backing is preferably 0.1 to 3 g/m². In a further, particularly preferred configuration the applied coat of release coating is set at 0.2 to 1.5 g/m². In order to achieve very good anchoring of the release layer - where appropriate, the first release layer—of the label of the invention to particular areas on the film, an adhesion promoter or primer is employed as a first layer. In this case the film surface facing the release coating is used. Solvent-based and water-based adhesion promoters are used between film and adhesive or other layers. Layers with a high affinity for backings and/or adhesion to backings based on thermoplastic films are likewise employed. The high affinity for surfaces of backings based on thermoplastic films governs the quality of such components for use as suitable adhesion promoters. As adhesion promoters for the release layer or first release layer, where appropriate, of the adhesive tapes it is possible for example to use aqueous adhesion promoters based on polyurethanes, polypropylenes with a low degree of chlorination, styrene-butadiene copolymers, and acrylates. Solventborne adhesion promoters are also suitable for the anchoring of subsequent layers in the adhesive tapes. These adhesion promoters are used as primers in the adhesive tape industry.

The coatweight of the primer layer on the backing is preferably 0.5 to 12 g/m². In a further, particularly preferred configuration the applied coat of first adhesion promoter layer is set at 1.5 to 6 g/m².

The primer layer is not applied over the full area to the backing surface facing the release coating. In order to obtain a visual security effect in the context of the application of the labels of the invention, the primer layer is applied to the film surface in a specific, incomplete way. In this context the application of the primer layer is designed such that only specific areas of the film surface are coated, forming, for example, the word “OPENED” or “VOID”. This type of application of the primer layer is made possible by means of suitable printing methods.

The areas on the film surface that are exposed by the incompletely applied primer layer preferably represent characteristic signs or symbols.

In the case of the three-layer variant, the release layer is applied over the full area to the primer layer and/or to the free surface areas of the film that is used.

Suitable release layers for the adhesive tapes include, for example, resin dispersions, acrylate dispersions or, generally, polymer dispersions or solventborne polymer solutions that, after drying, exhibit sufficient low adhesion to the backing, and brittleness.

Particular preference is given to suitable printing inks. In this context use is made, for example, of water-based, solvent-based or UV-curing flexographic printing inks as a layer. Ink layers of this kind are strongly coloured and suitable for application to the first layer and/or to the film by means of a wide variety of technologies. Through an appropriate choice of printing inks it is possible to adjust the layer system such that the layer is anchored very well to the primer layer yet has poor adhesion, or a poor bond, to those areas of the film not coated with the primer layer.

The coatweight of the release layer to the backing and/or the primer layer is preferably 2 to 18 g/m². In a further preferred configuration the applied coat of first layer is set at 5 to 11 g/m².

In the case of the four-layer variant the first release layer is applied over the full area to the primer layer and/or to the free surface areas of the film that is used, where appropriate only within the area described above.

The second release layer and/or, in particular, ink layer is applied over the full area, during production of the labels of the invention, to the first release layer, where appropriate only within the area described above.

For ready recognition of the opening securement, the first and second release layer and/or colour layer are preferably of different colour. Contrast colours increase the security effect with respect to the unnoticed removal of the label.

Suitability as second release layer for the label is possessed by aqueous or solventborne printing inks which, after drying, exhibit sufficiently low adhesion to the first release layer and a sufficient brittleness.

Appropriate fine-tuning of the chemical composition or matching and optimizing of the various polarities, brittlenesses and compositions of the first and second release layer produces the profile of properties described.

Preference is given, for example, to water-based, solvent-based or UV-curing flexographic printing inks for use as the second release layer.

Ink layers of this kind are strongly coloured and suitable for application by a wide variety of technologies to the first release layer.

The coatweight of the second release layer or ink layer to the first release layer is preferably 8 to 50 g/m². In a further preferred configuration the applied coat of the third layer or ink layer is set at 15 to 30 g/m².

As adhesives it is possible to employ substantially all known adhesives.

The adhesive of the adhesive tapes may be composed of an adhesive based on solventborne natural rubber adhesives and acrylate adhesives. Adhesives based on acrylate dispersions are preferred. These adhesive technologies are employed in the adhesive tape industry.

The coatweight of the adhesive on the backing is preferably 15 to 60 g/m². In a further preferred configuration the coat applied is set at 20 to 30 g/m².

Particularly suitable antiadhesive material for the liner is an antiadhesive release paper, based for example on bodies of paper with different degrees of compaction, and also release films based on PET, PP, and PE. The liner may have a silicone coating.

Furthermore, following removal from the roll but prior to the removal of the liner, the label can be used as an adhesive seal, by passing the label around the article to be sealed, and bonding the free section of the label, in other words the section not covered by the liner, to the label itself.

With further preference, moreover, the label has a cleavable backing, so that when the adhesive seal is broken open, by pulling on the two ends of the section, the backing cleaves irreversibly. As a result of the adhering adhesive, detachment of the label bonded to itself (seal function) is accompanied by visible destruction of its surface, as a result of fibre extraction.

This seal has the great advantage that the liner is not left as waste during application, requiring separate disposal, as is usually the case.

In a further preferred embodiment the cleavable backing used comprises, in particular, a cleavable system based preferably on sized and highly compacted paper, on a composite of paper and film or on a composite of two films, it being possible for the composite to be composed of films and/or papers joined linearly and/or pointwise in a defined fashion. Examples of papers, paper composite systems or films particularly suitable for this purpose include the following:
Duplex papers:
   Duplex papers are papers which are laminated together, for which the cleaving operation is extremely homogeneous, with no stress peaks, as a result, for example, of inhomogeneous compaction. These papers are commercially customary and are employed for example in the production of filter materials and wallcoverings.
Readily cleaving papers:
   These are highly compacted papers (i.e. papers with a high cleave resistance) that are sized together. Sizing can be done using, for example, starch, derivatives containing starch, methylcellulose-based wallpaper pastes (tesa® Kleister, tesa AG, Hamburg; Methylan®, Henkel KgaA, Düsseldorf) or else wallpaper pastes based on polyvinyl alcohol derivatives. Systems of this kind are described in EP 0 757 657 A1, for example. The cleave energy is adjusted via the compaction of the paper fibre structure. The lower the degree of compaction, the lower the cleavability.
Additionally suitable paper systems are, for example, machine-finished papers calendered on one side or else highly filled kraft papers.
Sized paper systems:
   The cleavability is adjusted via the chemistry of the size. The size ought not to have substantially penetrated the paper.
Additionally a cleaving system comprising a material which separates between top and bottom face under normal force (in accordance with DE 198 41 609 A1) can be used.
Coextruded films

It will be appreciated that the multi-layer backings described above can also be employed in the adhesive seal.

The label of the invention can be used in particular in two ways. On the one hand, the articles to be sealed can be surrounded such that the two ends of the label are each pressed against one another by their bottom faces, in other words by the adhesive side, producing the form of a loop.

On the other hand the end with the exposed adhesive may be bonded to the top face of the label, producing the form of a ring within which lies the article to be sealed.

The multi-layered labels expounded in detail above can also be used as adhesive seals. In that case the adhesive seal indicates unauthorized opening by the fact that, when the label is peeled from the surface to which it is adhered, areas of the label are extracted from the label and remain as a message on the surface, the message being imperceptible prior to detachment from the surface. The message remains perceptible even if the label, after having been detached, is replaced exactly on the original bond site.

The invention then embraces a process for producing a roll of a label web of labels disposed one behind another and composed at least of a backing coated on one side with an adhesive, the labels being lined with a liner on the adhesive side.

The process is composed of the following steps:
producing a label stock material by furnishing a continuous backing layer with an adhesive,
applying the label stock material to the continuous liner,
diecutting the labels from the label stock material, by diecutting the label stock material down to the liner, producing one, possibly two or more adjacent label webs,
diecutting the liner on the liner side down to the labels, diecutting taking place in cut lines which lie crosswise relative to the web direction, the cut lines of the liner lying in each case at an offset to the cross-cut lines of the labels, in such a way that at least one of the cut lines of the liner is beneath the labels,
if desired singularizing the adjacent label webs, in particular by slitting,
rolling up the label webs to form an Archimedean spiral.

Preferably the label stock material is cut by matrix cutting, the cut matrix being removed before the label webs are rolled up.

In an alternative variant of the process the liner is cut before the label stock material.

The label stock material is produced in a multi-stage operation, which is elucidated below by way of example for a relatively complex label.

The simpler the construction of the label, the greater the number of steps which would ultimately be omitted.

In a first step one of the surfaces of the backing is coated with a silicone-based release coating. This single-side treatment of the backing is realized with corresponding coating lines.

The film surface facing the release coating is subjected where appropriate to corona or flame pretreatment.

The primer layer with high affinity for the surface of the film that is used is applied by flexographic printing to the film surface facing the release coating.

Printing by means of flexography is used, among other applications, in the adhesive tape industry for the purpose of individualizing adhesive tapes.

It is carried out using printing plates whose raised portions transfer the first layer. The printing plates are flexible plates made of rubber or photopolymers. Flexographic printing components are of low viscosity, both solvent-based and water-based. They are quick-drying, particularly in the area of the radiation-curing systems. When producing the adhesive tapes of the invention it is preferred to use aqueous flexographic printing components. The selection of the patterned roller is guided by the print medium used and the associated flexographic printing component.

The application of the release layer or layers to the primer layer or to the exposed parts on the film surface is achieved, during the production of the adhesive tapes, by employing typical methods. Mention may be made in this context of the knifecoating of aqueous systems or of the coating of solventborne systems by means of coating bars, patterned rollers or printing techniques.

For the subsequent coating of the adhesive onto the layer, both coating bars and the knife technology are appropriate.

A further possibility is the application of adhesive based on styrene-isoprene-styrene as a hot-melt pressure-sensitive adhesive to the release layer by means of known technology in the production of adhesive tapes.

### BRIEF DESCRIPTION OF THE DRAWINGS

Using the figures described below, one particularly advantageous version of the roll of the invention, a process for producing it, and a section through the label along the line A-A are illustrated, without any intention thereby to restrict the invention unnecessarily.

FIG. 1 shows a label web of labels disposed one behind another and composed of a backing coated on one side with an adhesive, the labels being lined with a liner on the adhesive side, and also the respective cut lines,

FIG. 2 shows again the label web of FIG. 1, with one label being depicted in singularized form after cutting,

FIG. 3 shows a roll with the cut labels and also the cut liner, each label having a defined area in which additional layers are present,

FIG. 4 shows the removal of a label from the roll of FIG. 3 and also the label/liner arrangement,

FIG. 5 shows a sectional drawing along line A-A through the area of the label indicated above, the layer thicknesses being depicted in such a way that they allow optimum appreciation of the construction and the structure of the adhesive tape,

FIG. 6 shows a sectional drawing similar to FIG. 5, but showing the relations between the individual layers after the area has been broken open,

FIG. 7 shows a second sectional drawing along line A-A through the area of the label indicated above, the layer thicknesses being depicted in such a way that they allow optimum appreciation of the construction and the structure of the adhesive tape,

FIG. 8 shows a sectional drawing similar to FIG. 7, but showing the relations between the individual layers after the area has been broken open, and

FIG. 9 shows a sectional drawing of the dispensing operation, in which the label does not release from the liner, in the usual way, but instead the liner releases from the label. It is shown how the liner, as it lifts, singularizes the adhesive surface with the area situated above it in which the security effect is present, and hence also singularizes the adhesive seal.

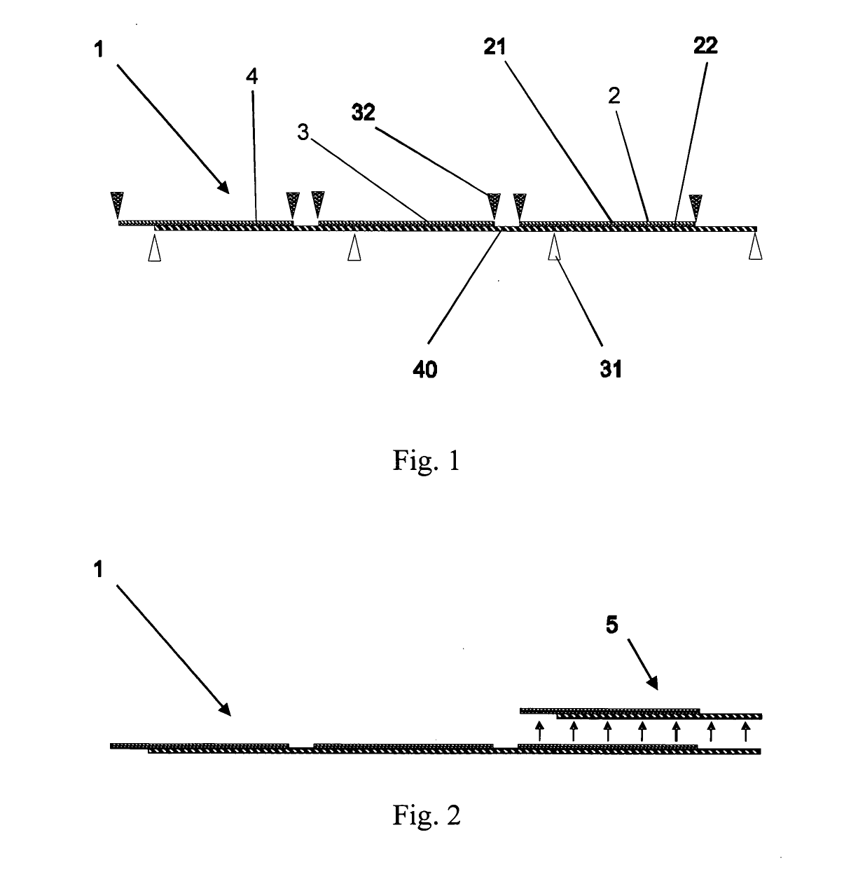

FIG. 1 shows a label web 1 of labels 2, 3, 4 which are disposed one behind another and are composed of a backing 21, coated on one side with an adhesive 22, the labels 2, 3, 4 being lined with a liner 40 on the adhesive side, and also the respective cut lines 31, 32. In accordance with the invention the liner 40 is cut through down to the labels 2, 3, 4, the cut lines 31 of the liner 40 lying at an offset to the cross-cut lines 32 of the labels 2, 3, 4 such that there is a cut line 31 of the liner 40 located beneath each label 2, 3, 4.

FIG. 2 again depicts the label web 1 of FIG. 1, with one label 5 being depicted in singularized form after cutting.

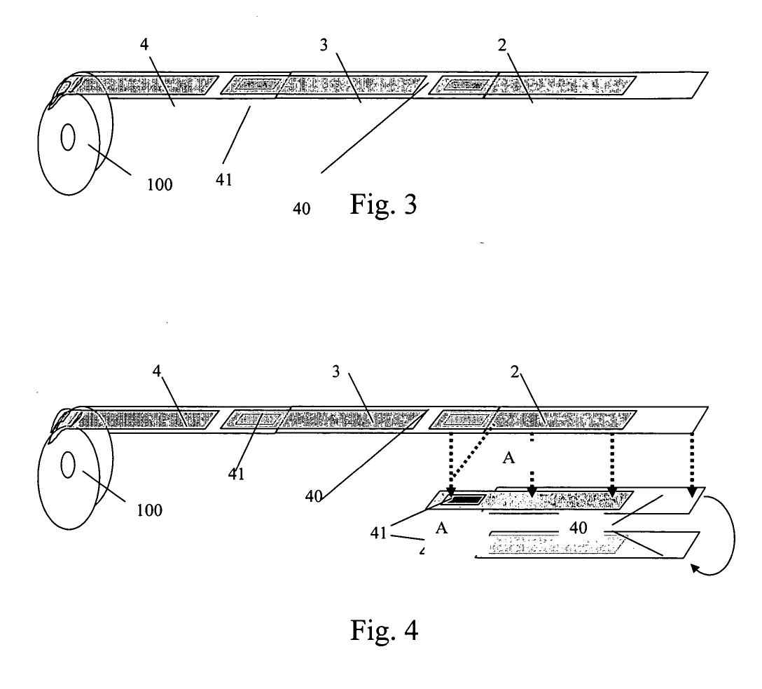

FIG. 3 shows a roll 100 with the cut labels 2, 3, 4 and the cut liner 40, each label 2, 3, 4 having a defined region 41, in which additional layers are present.

FIG. 4 shows the removal of a label 4 from the roll 100 of FIG. 3 and also the label 4/liner 40 arrangement. Also shown is the label 4 after rotation by 180°. The offset between label 4 and liner 40 results in a partial area on the label 4 that is adhesive and that acts as a grip tab, allowing the label 4 to be lifted easily from the liner 40.

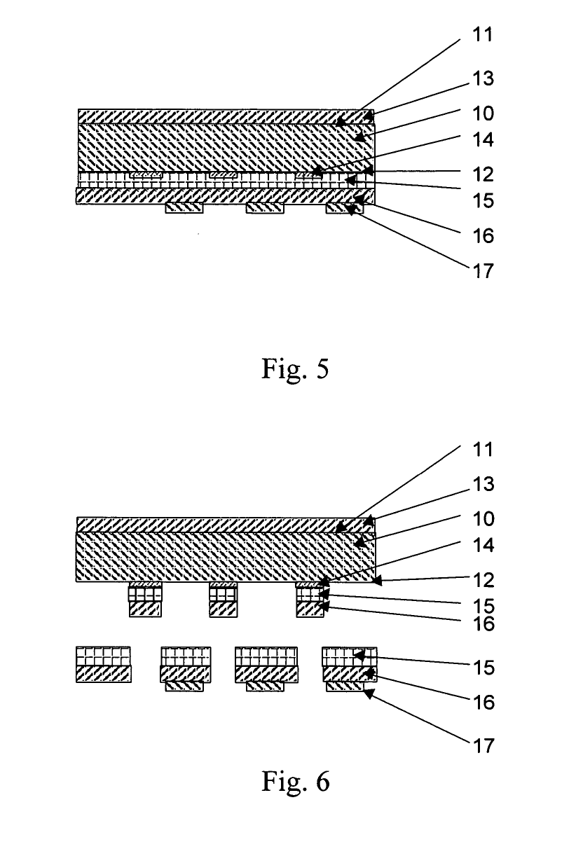

FIG. 5 shows a sectional drawing along line A-A through the above-indicated area 41 of the label 4, in which the layer thicknesses have been shown in such a way as to allow optimum appreciation of the construction and the structure.

In FIG. 5 the label 4 is composed of a preferably transparent thermoplastic film 10 with a sufficient internal strength.

Applied to the lower surface 12 of this film 10 in a first operation, in the area 41, is a transparent primer layer 14, not applied over the full area. The layer 14 is disposed on the film surface 12 in such a way as to produce a line of text which is perceptible in the event of the label being broken open.

In the second step a release layer 15 is applied to the primer layer 14 and the remaining film surface 12. The release layer 15 is composed of a coloured material. The colour and the colour density are selected so as on the one hand to offer a sufficient colour contrast, so that the line of text formed can be read, but also so as to allow an imprint located on the adhesive layer 16—of a company logo or trademark symbol—to show through and be readily perceptible.

Next, the adhesive layer 16, which ensures sufficient bonding reliability, is applied to the release layer 15.

In relative terms the attachment of the primer layer 14 to the film surface 12 is very strong. The release layer 15 attaches to the film surface 12 only with relative weakness, but to the primer layer 14 with relative strength.

The attachment of the release layer 15 to the film surface 12 is lower than the attachment of the release layer 15 to the adhesive layer 16.

Applied to the top face 11 of the film backing 10 is a preferably transparent release layer 13, which attaches relatively strongly to the surface 11.

In this operation or in a further operation it is possible to apply a coloured imprint 17 of a company logo or trademark symbol to the outer surface of the adhesive 16.

As a result of the preferred transparency of the release layer 13 and of the film backing 10, and also of the primer layer 14, the uniform colour of the ink layer 15 is visible, and, where appropriate, the ink layer 17 showing through the adhesive layer 16.

If the label 4 is broken open, as shown in FIG. 5, the label 4 is parted as in FIG. 6. In the area in which it is in direct contact with the film surface 12, the release layer 15 parts from the film 10. In the area in which the primer layer 14 is located, the adhesive layer 16 remains on the backing film 10. The word “OPENED”, for example, is visible as a line of text and as a direct coloured line of text on the backing 10.

Additionally, as a result of the deformation of the backing 10 during application and detachment, the line of text on the backing film 10 can no longer be inserted congruently into the exposed line of text.

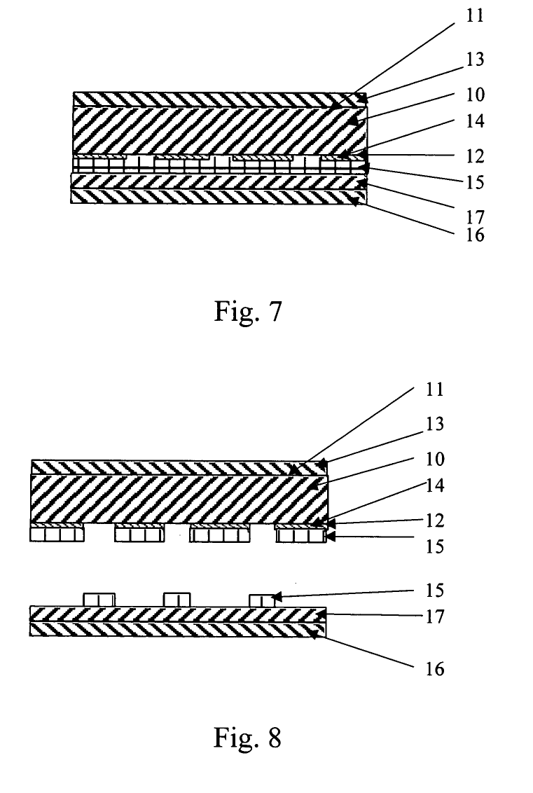

FIG. 7 shows a second sectional drawing along line A-A through the above-indicated area 41 of the label 4, in which the layer thicknesses have been shown in such a way as to allow optimum appreciation of the construction and the structure.

In FIG. 7 the label 4 is composed of a preferably transparent thermoplastic film 10 with a sufficient internal strength, which ensures the service described.

Applied to the lower surface 12 of this film 10 in a first operation, in the area 41, is a transparent primer layer 14, not applied over the full area. The layer 14 is disposed on the film surface 12 in such a way as to produce a line of text which is perceptible in the event of the label being broken open.

In the second step a first release layer 15 is applied to the primer layer 14 and the remaining film surface 12. The release layer 15 is composed of a coloured material. The coloured release layer 15 is applied not only to the film surface 12 between the area of the primer layer 14 but also specifically on the primer layer 14 itself.

In a third step a second release layer 17 is applied to the release layer 15. The release layer 17 preferably has a different colour from the release layer 15.

Next, the adhesive layer 16, which ensures sufficient bonding reliability, is applied to the release layer 17.

In relative terms the attachment of the primer layer 14 to the film surface 12 is very strong. The release layer 15 attaches to the film surface 12 only with relative weakness, but to the primer layer 14 with relative strength. The release layer 17 attaches only weakly to the release layer 15.

The attachment of the release layer 15 to the film surface 12 is lower than the attachment of the release layer 17 to the release layer 15. The adhesive layer 16 attaches to the release layer 17 more strongly than the release layer 15 to the film surface 12. The adhesive layer 16 attaches to the release layer 17 preferably more strongly than to the release layer 15.

Applied to the top face 11 of the film backing 10 is a preferably transparent release layer 13, which attaches relatively strongly to the surface 11.

If the label 4 is broken open, as shown in FIG. 7, the label 4 parts as in FIG. 8. In the area in which it is in direct contact with the film surface 12, the release layer 15 parts from the film 10. In the area in which the primer layer 14 is located, the release layer 15 parts from the release layer 17 and remains on the film 10. Over the full area, the adhesive 16 remains in a bond with the release layer 17. Remaining on the release layer 17 is the area of the release layer 15 that has parted from the film surface 12. The word “OPENED”, for example, can be read as a line of text on the release layer 17 and as an inverse transparent line of text on the backing 10.

In addition, as a result of the deformation of the backing 10 during application and detachment, it is no longer possible to insert the line of text on the backing film 10 congruently into the exposed line of text.

A further indicator that the label has already been detached once is that the parting of the layers 15, 17 is irreversible and that, therefore, the attachment of the layers 15, 17 placed one atop the other is not sufficient.

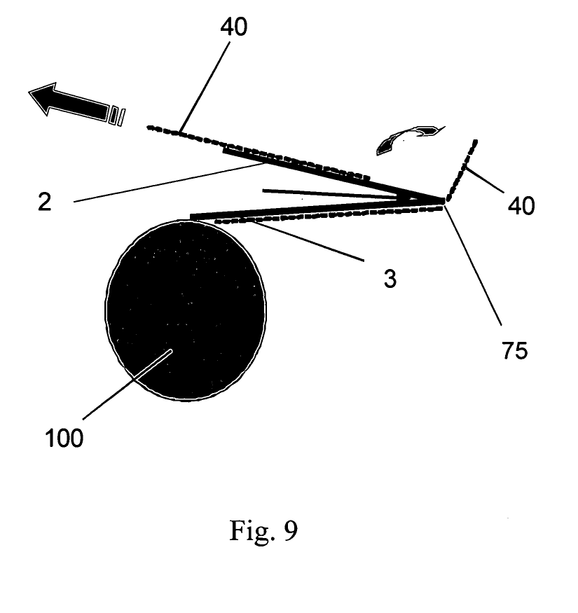

FIG. 9 shows a label roll 100 in a sectional drawing, and also the course of the dispensing operation.

The labels 2, 3 connect the individual sections of the liner 40 to one another, by bridging the sections. A multiplicity of individual labels, 2, 3 joined to one another by attachment via the liner 40 can be wound in this way to form a roll 100, and transported and dispensed compactly, taking up little space.

In the dispensing operation the label 2, 3 does not peel off from the liner 40 in the usual way; instead, the liner 40 peels off from the label 2, 3. As it lifts, the liner 40 exposes the adhesive surface with the area 41 above it in which the security effect is present, and hence the adhesive seal is singularized as well. This adhesive seal is therefore ready for adhesive use. Following singularization, there is no need for the user to remove the liner 40 in an additional work-up step. Another particular advantage is that at application there is no waste which would require disposal in a further work-step.

1. Roll of a label web in the form of an Archimedean spiral of labels disposed one behind another and composed at least of a backing coated on one side with an adhesive, the labels being lined with a liner on the adhesive side, wherein the liner is diecut down to the labels and additionally forms a continuous web divided into individual sections, and cut lines of the liner are located at an offset to cross-cut lines of the labels such that beneath each label there is at least one cut line of the liner.

2. Roll of a label web of labels disposed one behind another according to claim 1, wherein the labels disposed one behind another are each disposed at a distance from one another on the liner.

3. Roll of a label web of labels disposed one behind another according to claim 1, wherein beneath a label there is only one single cut line of the liner.

4. Roll of a label web of labels disposed one behind another according to claim 1, wherein the cut line of the liner is in the vicinity of a back edge of the label as viewed in a web direction.

5. Roll of a label web of labels disposed one behind another according to claim 1, wherein the roll is wound such that relative to a roll center the liner represents an inner ply and the labels represent an outer ply.

6. Roll of a label web of labels disposed one behind another according to claim 1, wherein the labels have a width of 20 to 25 mm and a length of 140 to 160 mm and the cut line of the liner is at a distance of between 20 and 30 mm from a back edge of the label.

7. A method of producing an adhesive seal, comprising providing a label from the roll according to claim 1, passing the label around an article to be sealed, and sticking the label to itself.

8. Method according to claim 7, wherein the label has a cleavable backing, so that when a seal of originality is broken open by pulling on the label, the backing cleaves irreversibly.

9. Process for producing a roll of a label web of labels disposed one behind another and composed at least of a backing coated on one side with an adhesive, the labels being lined with a liner on the adhesive side, said process comprising the following steps:
a) producing a label stock material by furnishing a continuous backing layer with an adhesive,
b) applying the label stock material to the continuous liner,
c) diecutting the labels from the label stock material, by diecutting the label stock material down to the liner, producing one, or more adjacent label webs,
d) diecutting the liner on the liner side down to the labels, diecutting taking place in cut lines which lie crosswise relative to the web direction, the cut lines of the liner lying in each case at an offset to the cross-cut lines of the labels, in such a way that at least one of the cut lines of the liner is beneath the labels, and the liner additionally forming a continuous web divided into individual sections,
e) optiomally singularizing the adjacent label webs, and
f) rolling up the label webs to form an Archimedean spiral.

10. Process according to claim 9, wherein the label stock material is cut by matrix cutting, the cut matrix being removed before the label webs are rolled up.

11. Process according to claim 9, wherein the liner is cut before the label stock material.
